(19) United States
(12) Patent Application Publication
(10) Pub. No.: US 2024/0202411 A1
(43) Pub. Date: Jun. 20, 2024

(54) CHIP VERIFICATION STRUCTURE, CHIP VERIFICATION SYSTEM, AND CHIP VERIFICATION METHOD

(71) Applicant: Suzhou PowerOn IC Design Co.,Ltd., Suzhou (CN)

(72) Inventors: Bingkun LIU, Suzhou (CN); Huazheng RUI, Suzhou (CN); Chong SUN, Suzhou (CN); Yan LI, Suzhou (CN); Mengli SHEN, Suzhou (CN); Changshen ZHAO, Suzhou (CN)

(73) Assignee: Suzhou PowerOn IC Design Co.,Ltd., Suzhou (CN)

(21) Appl. No.: 18/336,249

(22) Filed: Jun. 16, 2023

(30) Foreign Application Priority Data
Dec. 16, 2022 (CN) 202211627995.5

(51) Int. Cl. G06F 30/347

(52) U.S. Cl. CPC G06F 30/347

(57) ABSTRACT

Disclosed are a chip verification structure, a chip verification system, and a chip verification method. The chip verification structure includes an analog chip, the analog chip includes at least one analog module. Since the analog chip is homologous with the sample of the chip design, a functional difference between the analog chip and the analog function module of the chip design may be reduced. Since the analog chip is connected to the FPGA chip via the plurality of types of interfaces, a difference between an interface of the analog chip and the FPGA chip and an interface of the analog function module and the digital function module of the chip design may be reduced, so that a verification accuracy of the chip design may be improved and a verification period of the chip design may be reduced.

### CROSS-REFERENCE TO RELATED APPLICATIONS

The present application claims priority to Chinese Patent Application No. 202211627995.5, filed on Dec. 16, 2022, all contents of which are incorporated herein in its entirety by reference.

### TECHNICAL FIELD

The present disclosure relates to the field of chip design technologies, and in particular, to a chip verification structure, a chip verification system, and a chip verification method.

### BACKGROUND

With the continuous increase of chip integration and the diversification of market requirements, a design of integrating a digital function module and an analog function module in one chip, such as a digital-analog hybrid chip design or a System on Chip (SOC) design, gradually occupies more positions in a chip market. However, the design brings greater difficulties to chip simulation verification.

Currently, the digital function module of a chip design may be simulated via a Field Programmable Gate Array (FPGA), and the analog function module of the chip design may be simulated via a peripheral discrete circuit to perform function verification of the chip design. However, the discrete circuit is an electronic circuit including a resistor, a capacitor, a diode, a triode, a field effect transistor, and the like, and is different from an actual chip in interface and function, and thus a verification result of the chip design is not completely matched with an actual result, resulting in poor verification accuracy of the chip.

### SUMMARY

The present disclosure discloses a chip verification structure, a chip verification system, and a chip verification method, to improve verification accuracy of a chip.

In a first aspect, the present disclosure discloses a chip verification structure, including an analog chip, the analog chip including at least one analog module, and the analog module is configured to simulate a function of an analog function module of a chip design; the analog chip being homologous with a sample of the chip design; and the analog chip is connected to an FPGA chip via a plurality of types of interfaces, where the FPGA chip includes at least one digital module, the digital module is configured to simulate a function of a digital function module of the chip design, and a function of the chip design is verified based on a simulation result of the analog module and the digital module.

In some optional embodiments, the analog chip is connected to the FPGA chip at least via an IO interface and a communication protocol interface, and the chip verification structure further includes a control module, the analog chip is connected to a GPIO interface of the FPGA chip via the IO interface, a first signal output by the analog chip is transmitted to the FPGA chip via the IO interface and the GPIO interface, and a second signal output by the FPGA chip is transmitted to the analog chip via the IO interface and the GPIO interface; and the analog chip is connected to the FPGA chip via the control module and the communication protocol interface, a third signal output by the analog chip, after being processed by the control module, is transmitted to the FPGA chip via the communication protocol interface, and a fourth signal output by the FPGA chip is transmitted to the control module via the communication protocol interface, processed by the control module and then transmitted to the analog chip.

In some optional embodiments, the analog chip includes a plurality of analog modules, and the plurality of analog modules are respectively configured to simulate functions of a plurality of analog function modules of the chip design.

In some optional embodiments, the chip verification structure further includes a register file, the register file includes a plurality of registers, the plurality of registers have a one-to-one mapping relationship with the plurality of analog modules, and the control module transmits the fourth signal which is processed to a corresponding analog module via the register file.

In some optional embodiments, the communication protocol interface includes a serial communications interface, and the control module includes a serial-parallel conversion unit, an encoding and decoding unit, and a processing unit; and the serial-parallel conversion unit is configured to perform serial-to-parallel conversion processing or parallel-to-serial conversion processing on the third signal or the fourth signal, the encoding and decoding unit is configured to perform encoding processing or decoding processing on the third signal or the fourth signal; and the processing unit is configured to transmit the third signal which is processed to the analog chip and transmit the fourth signal which is processed to the serial communications interface.

In some optional embodiments, the control module further includes an error check unit, and the error check unit is configured to perform error check and correction on the third signal or the fourth signal.

In some optional embodiments, the first signal includes a timing related signal, the third signal includes a timing non-related signal, the timing related signal is transmitted via the IO interface, and the timing non-related signal is transmitted via the communication protocol interface.

In some optional embodiments, the timing related signal includes a signal that is strongly related to timing control, and the timing non-related signal includes a signal that is weakly related to timing control.

In some optional embodiments, the timing related signal includes an enable signal, a reset signal, a clock signal, a handshake signal, a bus signal, a control signal, and a state signal, and the timing non-related signal includes a trim signal and a calibration signal.

In some optional embodiments, the analog chip outputs a waveform via the IO interface, so as to observe a simulation result of the analog chip based on the waveform.

In some optional embodiments, the analog chip being homologous with the sample of the chip design includes that the analog chip and the sample of the chip design are from a same MPW wafer.

In a second aspect, the present disclosure discloses a chip verification system including a chip verification structure, where the chip verification structure includes an analog chip, the analog chip including at least one analog module, and the analog module is configured to simulate a function of an analog function module of a chip design, the analog chip being homologous with a sample of the chip design; and the analog chip is connected to an FPGA chip via a plurality of types of interfaces, where the FPGA chip includes at least one digital module, the digital module is configured to simulate a function of a digital function module of the chip design, and a function of the chip design is verified based on a simulation result of the analog module and the digital module.

In some optional embodiments, the analog chip is connected to the FPGA chip at least via an IO interface and a communication protocol interface, and the chip verification structure further includes a control module, the analog chip is connected to a GPIO interface of the FPGA chip via the IO interface, a first signal output by the analog chip is transmitted to the FPGA chip via the IO interface and the GPIO interface, and a second signal output by the FPGA chip is transmitted to the analog chip via the IO interface and the GPIO interface; and the analog chip is connected to the FPGA chip via the control module and the communication protocol interface, a third signal output by the analog chip, after being processed by the control module, is transmitted to the FPGA chip via the communication protocol interface, and a fourth signal output by the FPGA chip is transmitted to the control module via the communication protocol interface, processed by the control module and then transmitted to the analog chip.

In some optional embodiments, the analog chip includes a plurality of analog modules, and the plurality of analog modules are respectively configured to simulate functions of a plurality of analog function modules of the chip design.

In some optional embodiments, the chip verification structure further includes a register file, the register file includes a plurality of registers, the plurality of registers have a one-to-one mapping relationship with the plurality of analog modules, and the control module transmits the fourth signal which is processed to a corresponding analog module via the register file.

In some optional embodiments, the communication protocol interface includes a serial communications interface, and the control module includes a serial-parallel conversion unit, an encoding and decoding unit, and a processing unit; and the serial-parallel conversion unit is configured to perform serial-to-parallel conversion processing or parallel-to-serial conversion processing on the third signal or the fourth signal, the encoding and decoding unit is configured to perform encoding processing or decoding processing on the third signal or the fourth signal; and the processing unit is configured to transmit the third signal which is processed to the analog chip and transmit the fourth signal which is processed to the serial communications interface.

In some optional embodiments, the control module further includes an error check unit, and the error check unit is configured to perform error check and correction on the third signal or the fourth signal.

In some optional embodiments, the first signal includes a timing related signal, the third signal includes a timing non-related signal, the timing related signal is transmitted via the IO interface, and the timing non-related signal is transmitted via the communication protocol interface.

In some optional embodiments, the timing related signal includes a signal that is strongly related to timing control, and the timing non-related signal includes a signal that is weakly related to timing control.

In some optional embodiments, the timing related signal includes an enable signal, a reset signal, a clock signal, a handshake signal, a bus signal, a control signal, and a state signal, and the timing non-related signal includes a trim signal and a calibration signal.

In a third aspect, the present disclosure discloses a chip verification method, including: performing parameter configuration for an FPGA chip and a chip verification structure, where the chip verification structure includes an analog chip, the analog chip includes at least one analog module, and the analog module is configured to simulate a function of an analog function module of a chip design; the FPGA chip includes at least one digital module, and the digital module is configured to simulate a function of a digital function module of the chip design; and the analog chip is connected to an FPGA chip via a plurality of types of interfaces, and the analog chip being homologous with a sample of the chip design; and performing a simulation test on the analog chip via the FPGA chip; and determining, based on a test result of the analog chip, whether the analog chip satisfies a verification requirement.

According to the chip verification structure, the chip verification system, and the chip verification method disclosed in the present disclosure, a function of an analog function module of a chip design is simulated by an analog module of an analog chip, and a function of the digital function module of the chip design is simulated by a digital module of an FPGA chip. Since the analog chip being homologous with a sample of the chip design, a functional difference between the analog chip and the analog function module of the chip design may be reduced. Since the analog chip is connected to the FPGA chip via a plurality of types of interfaces, a difference between an interface of the analog chip and the FPGA chip and an interface of the analog function module and the digital function module of the chip design may be reduced, so that a verification accuracy of the chip design may be improved and a verification period of the chip design may be reduced.

### BRIEF DESCRIPTION OF THE DRAWINGS

To describe the technical solutions in the embodiments of the present disclosure or the background more clearly, the following describes the accompanying drawings required in the embodiments of the present disclosure or the background.

FIG. 1 is a schematic diagram of a chip verification structure according to an embodiment of the present disclosure.

FIG. 2 is a schematic diagram of a chip verification structure according to another embodiment of the present disclosure.

FIG. 3 is a schematic diagram of a chip verification structure according to another embodiment of the present disclosure.

FIG. 4 is a schematic diagram of a chip verification structure according to another embodiment of the present disclosure.

FIG. 5 is a schematic diagram of a chip verification structure according to another embodiment of the present disclosure.

FIG. 6 is a schematic diagram of a chip verification system according to an embodiment of the present disclosure.

FIG. 7 is a flowchart of a chip verification method according to an embodiment of the present disclosure.

### DETAILED DESCRIPTION OF THE EMBODIMENTS

The following clearly and completely describes the technical solutions in the embodiments of the present application with reference to the accompanying drawings in the embodiments of the present application. Apparently, the described embodiments are only some rather than all of the embodiments of the present application. All other embodiments obtained by a person of ordinary skill in the art based on the embodiments of the present application without creative efforts shall fall within the protection scope of the present application.

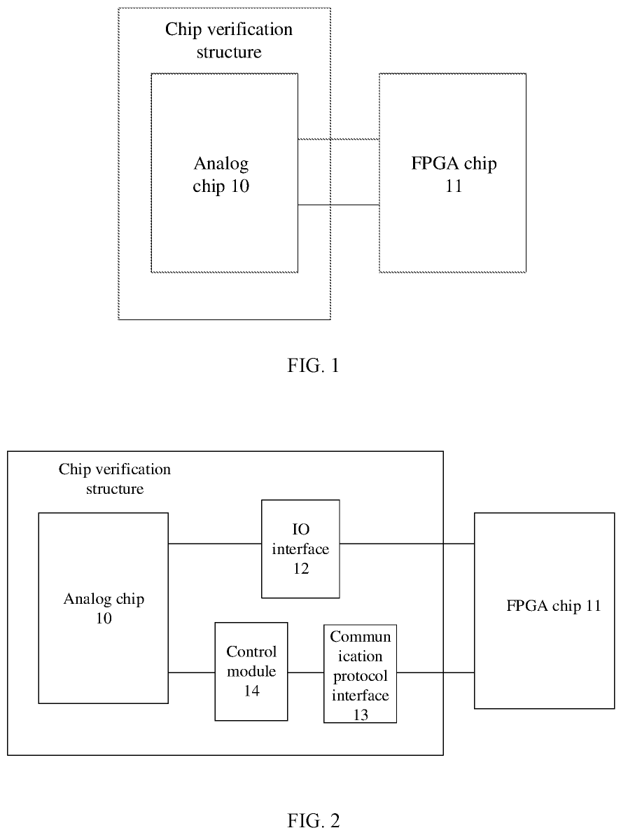

In an optional embodiment of the present disclosure, an embodiment of the present disclosure discloses a chip verification structure. As shown in FIG. 1, FIG. 1 is a schematic diagram of a chip verification structure according to an embodiment of the present disclosure. The chip verification structure includes an analog chip 10, the analog chip 10 includes at least one analog module, and the analog module is configured to simulate a function of an analog function module of a chip design. The analog chip 10 being homologous with a sample of the chip design.

The analog chip 10 being homologous with the sample of the chip design includes that the analog chip 10 and the sample of the chip design are from a same Multi-Project Wafer (MPW). In other words, the analog chip 10 and the sample of the chip design have a same manufacturing process, and both are taped out on a same wafer. On such a basis, a peripheral discrete circuit may be simplified or omitted, a difference of Process Design Kit (PDK) parameters and a Fabrication (FAB) process between the analog chip 10 and the chip design may be reduced, and thus a functional difference between the analog chip 10 and the analog function module of the chip design may be reduced, so that a verification accuracy of the chip design may be improved and a verification period of the chip design may be reduced.

Moreover, the analog chip 10 is connected to the FPGA chip 11 via a plurality of types of interfaces, where the FPGA chip 11 includes at least one digital module, the digital module is configured to simulate a function of a digital function module of the chip design, and a function of the chip design is verified based on a simulation result of the analog chip 10 and the FPGA chip 11. The analog function module is a function module that performs operations such as transmission, transformation, processing, and amplification on an analog signal, and the digital function module is a function module that uses a digital signal to complete an arithmetic operation and a logical operation on digital quantities.

Since the analog chip 10 may be connected to the FPGA chip 11 via the plurality of types of interfaces, a difference between an interface of the analog chip 10 and the FPGA chip 11 and an interface of the analog function module and the digital function module of the chip design may be reduced, so that the verification accuracy of the chip design may be improved and the verification period of the chip design may be reduced.

In some embodiments of the present disclosure, as shown in FIG. 2, FIG. 2 is a schematic diagram of a chip verification structure according to another embodiment of the present disclosure. An analog chip 10 is connected to an FPGA chip 11 at least via an Input/Output Interface (IO Interface) 12 and a communication protocol interface 13, and the chip verification structure further includes a control module 14.

The analog chip 10 may be connected to a General-Purpose Input Output (GPIO) interface of the FPGA chip 11 via the IO interface 12, a first signal output by the analog chip 10 is transmitted to the FPGA chip 11 via the IO interface 12 and the GPIO interface, and a second signal output by the FPGA chip 11 is transmitted to the analog chip 10 via the IO interface 12 and the GPIO interface. The analog chip 10 is connected to the FPGA chip 11 via the control module 14 and the communication protocol interface 13. A third signal output by the analog chip 10 is processed by the control module 14 and then transmitted to the FPGA chip 11 via the communication protocol interface 13, and a fourth signal output by the FPGA chip 11 is transmitted to the control module 14 via the communication protocol interface 13, processed by the control module 14 and then transmitted to the analog chip 10.

Since a quantity of pins on the GPIO interface of the FPGA chip 11 is limited, if all signals of the analog chip 10 are introduced into the pins on the GPIO interface pin of the FPGA chip 11, a case of insufficient pins often occurs. Therefore, in some embodiments of the present disclosure, some of signals between the analog chip 10 and the FPGA chip 11 is transmitted via the communication protocol interface 13, which may not only reduce a limitation on type selection of the FPGA chip 11, but also implement automatic transmission of signals between the analog chip 10 and the FPGA chip 11 via the communication protocol interface 13 in a case that relatively few pins on the GPIO interface are occupied.

In addition, the analog chips 10 with different functions may be applied to the chip verification structure in the embodiment of the present disclosure to reuse the interfaces, the control module 14, and the like in the chip verification structure, thereby improving reusability of the chip verification structure.

In some embodiments of the present disclosure, the first signal includes a timing related signal, and the third signal includes a timing non-related signal. In other words, the timing related signal is transmitted via the IO interface 12, and the timing non-related signal is transmitted via the communication protocol interface 13. The timing related signal may be a signal that is strongly related to timing control, and the timing non-related signal may be a signal that is weakly related to timing control.

In some embodiments, the timing related signal includes an enable signal, a reset signal, a clock signal, a handshake signal, a bus signal, a control signal, a state signal, and the like. The timing non-related signal includes a trim signal, a calibration signal, and the like. Certainly, the present disclosure is not limited thereto. In some other embodiments, the first signal and the third signal may alternatively be divided according to another signal type, and details are not described herein again.

Since the trim signal and the calibration signal are numerous and belong to different the analog function modules, the communication protocol interface 13 is required to ensure transmission of these signals. It may be understood that, the enable signal, the reset signal, the clock signal, the handshake signal, the bus signal, the control signal, the state signal, and the like may be transmitted to the FPGA chip 11 via different IO interfaces, and details are not described herein again.

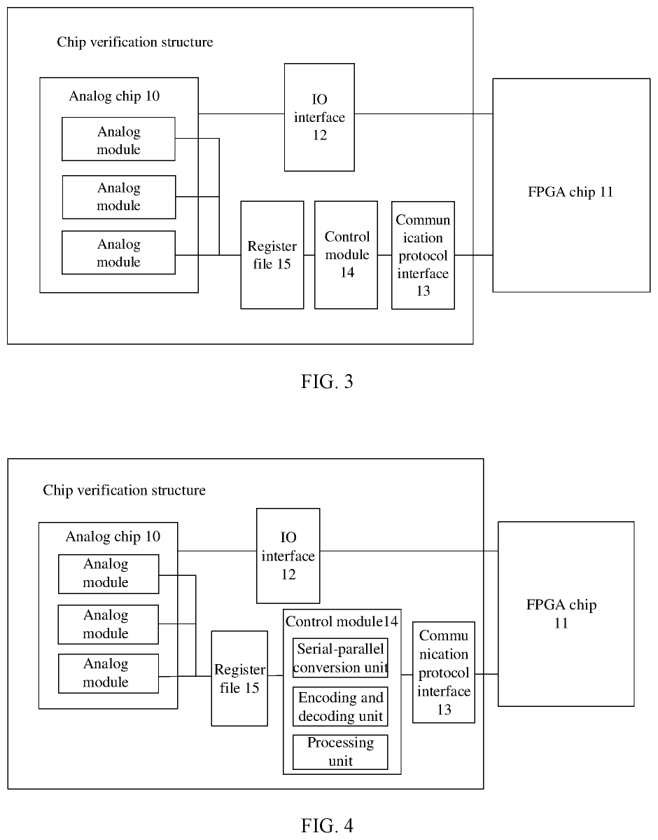

In some embodiments of the present disclosure, as shown in FIG. 3, FIG. 3 is a schematic diagram of a chip verification structure according to another embodiment of the present disclosure. An analog chip 10 includes a plurality of analog modules, and the plurality of analog modules are respectively configured to simulate functions of a plurality of analog function modules of a chip design. The chip verification structure further includes a register file 15, the register file 15 includes a plurality of registers, and the plurality of registers have a one-to-one mapping relationship with the plurality of analog modules. A control module 14 transmits the fourth signal which is processed to a corresponding analog module via the register file 15.

The register file 15 may be an array composed of a plurality of registers. Since the plurality of registers have a one-to-one mapping relationship with the plurality of analog modules, the control module 14 may determine a source of an analog module of a signal based on a source of the register of the signal, so that the signal may be transmitted to a digital module, corresponding to the analog module, in the FPGA chip 11.

In some embodiments of the present disclosure, the communication protocol interface 13 includes a serial communications interface. Certainly, the present disclosure is not limited thereto. In some other embodiments, the communication protocol interface 13 may further include a Joint Test Action Group (JTAG) interface and the like.

On such a basis, in some embodiment of the present disclosure, as shown in FIG. 4, FIG. 4 is a schematic diagram of a chip verification structure according to another embodiment of the present disclosure. A control module 14 includes a serial-parallel conversion unit, an encoding and decoding unit, and a processing unit. The serial-parallel conversion unit is configured to perform serial-to-parallel conversion processing or parallel-to-serial conversion processing on a third signal or a fourth signal, the encoding and decoding unit is configured to perform encoding processing or decoding processing on the third signal or the fourth signal; and the processing unit is configured to transmit the third signal which is processed to the analog chip and transmit the fourth signal which is processed to the serial communications interface.

On such a basis, parallel-to-serial conversion processing is performed on the third signal output by the analog module via the serial-parallel conversion unit, encoding processing is performed on the third signal by the encoding and decoding unit, and the communication protocol interface 13 is determined by the processing unit, and the third signal is transmitted to the FPGA chip 11 via the corresponding communication protocol interface 13. After the fourth signal output by the FPGA chip 11 is transmitted to the control module 14 via the corresponding communication protocol interface 13, serial-to-parallel conversion processing is performed on the fourth signal by the serial-parallel conversion unit, decoding processing is performed on the fourth signal by the encoding and decoding unit, and the corresponding analog module is determined by the processing unit. Then the fourth signal is transmitted to the corresponding analog module via the register file 15.

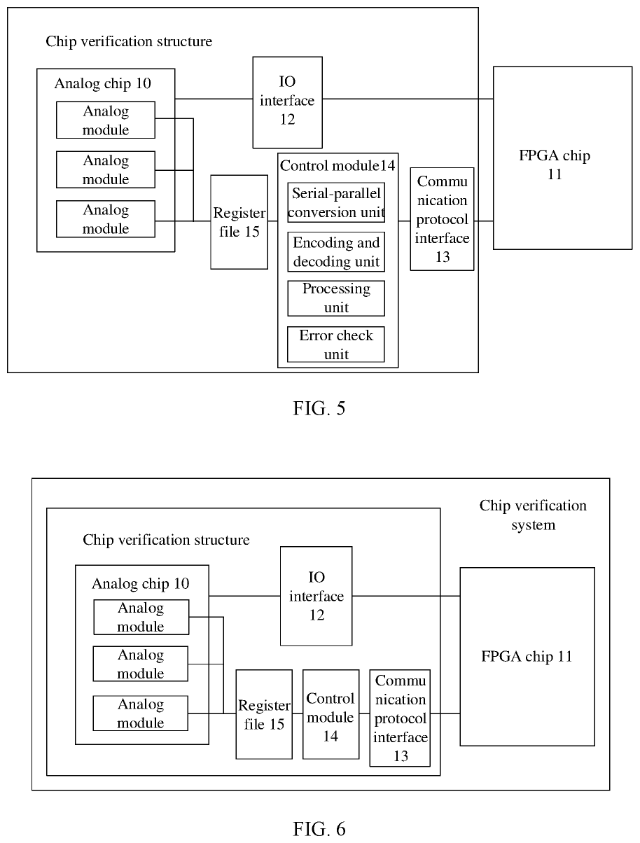

In some embodiments of the present disclosure, as shown in FIG. 5, FIG. 5 is a schematic diagram of a chip verification structure according to another embodiment of the present disclosure. The control module 14 further includes an error check unit, and the error check unit is configured to perform error check and correction on a third signal or a fourth signal.

It may be understood that, function units in the control module 14 may be configured according to actual requirements. For example, if there is no need to perform an error check in some control modules 14, the some control modules 14 may not include the error check unit.

In some embodiments of the present disclosure, an analog chip 10 outputs a waveform via one of IO interfaces, so as to observe a simulation result of the analog chip 10 based on the waveform. The IO interface may be connected to a waveform display device such as an oscilloscope, so as to observe the waveform by means of the waveform display device such as the oscilloscope, to obtain the simulation result of the analog chip 10.

In another optional embodiment of the present disclosure, an embodiment of the present disclosure discloses a chip verification system. As shown in FIG. 6, FIG. 6 is a schematic diagram of a chip verification system according to an embodiment of the present disclosure. The chip verification system includes a chip verification structure according to any one of the embodiments described above and an FPGA chip. According to the chip verification system, a verification accuracy of a chip design may be improved, and a verification period of the chip design may be reduced.

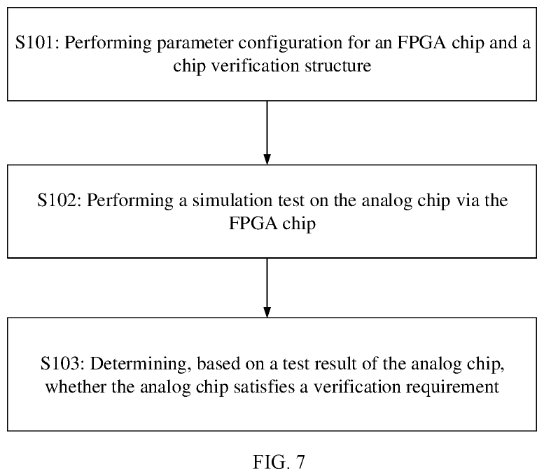

In another optional embodiment of the present disclosure, an embodiment of the present disclosure discloses a chip verification method. As shown in FIG. 7, FIG. 7 is a flowchart of a chip verification method according to an embodiment of the present disclosure, and the chip verification method includes the following steps.

S101: performing parameter configuration for an FPGA chip and a chip verification structure.

As shown in FIG. 1, the chip verification structure includes an analog chip 10, the analog chip 10 includes at least one analog module, and the analog module is configured to simulate a function of an analog function module of a chip design. An FPGA chip 11 includes at least one digital module, and the digital module is configured to simulate a function of a digital function module of the chip design. Moreover, the analog chip 10 is connected to the FPGA chip 11 via a plurality of types of interfaces, and the analog chip 10 is homologous with the chip design. It may be understood that, the chip verification structure may be a chip verification structure according to any one of the embodiments described above.

Before chip verification is performed, a chip verification system needs to perform power-on self-test, to establish an initial power supply and a clock system, so as to ensure normal operation of subsequent operations. Then, the FPGA chip 11 and the chip verification structure may be configured. A configuration signal may be transmitted to the analog chip 10 via a GPIO interface and an IO interface 12 of the FPGA chip 11 to configure a first signal of the analog chip 10, such as an enable signal, a reset signal, a clock signal, a handshake signal, and the like.

Then, after content related to a communication protocol is configured for the FPGA chip 11, an analog module of the analog chip 10 may be configured via a communication protocol interface 13 of the FPGA chip 11. The content related to the communication protocol includes a command word, data, and the like, where the command word included a read-write bit, an address, and a length. The analog module in the analog chip 10 may be accessed and modified via the command word.

S102: performing a simulation test on the analog chip via the FPGA chip.

After parameter configuration is performed for the FPGA chip and the chip verification structure, a test stage starts. The FPGA chip 11 continuously sends a command word and data to the analog module of the analog chip 10 via the communication protocol interface 13 to complete the simulation test of functions of all analog modules in the analog chip 10.

S103: determining, based on a test result of the analog chip, whether the analog chip satisfies a verification requirement.

In some embodiments, a test result of the analog module of the analog chip 10 may be observed based on a waveform output by the analog chip 10, to determine whether the analog module of the analog chip satisfies a verification requirement of the chip verification system, especially to determine whether a trim signal and a calibration signal output by the analog module satisfies the verification requirement of the chip verification system. In some embodiments, steps S101 and S102 will be repeated a plurality of times to eliminate an impact of process variation.

It may be understood that, when it is determined that the analog chip satisfies the verification requirement, the analog chip 10 and the FPGA chip 11 may be controlled to perform simulation verification, and the functions of the chip design is verified based on a simulation result of the analog chip 10 and the FPGA chip 11.

The technical features of the foregoing embodiments may be combined arbitrarily. To make the description concise, not all possible combinations of the various technical features in the foregoing embodiments are described. However, as long as there is no contradiction in the combination of these technical features, it should be considered that these technical features are within the scope of this specification.

The foregoing embodiments describe only several embodiments of this specification, and the description is relatively specific and detailed, but should not be understood as a limitation to the patent scope of the present disclosure. It should be noted that those of ordinary skill in the art may further make several variations and improvements without departing from the concept of this specification, and all these variations and improvements fall within the protection scope of this specification. Therefore, the protection scope of this specification shall be subject to the protection scope of the appended claims.

What is claimed is:

1. A chip verification structure, comprising an analog chip, the analog chip comprising at least one analog module, and the analog module being configured to simulate a function of an analog function module of a chip design, the analog chip being homologous with a sample of the chip design;
wherein the analog chip is connected to a field programmable gate array (FPGA) chip via a plurality of types of interfaces, the FPGA chip comprises at least one digital module, the digital module is configured to simulate a function of a digital function module of the chip design, and a function of the chip design is verified based on a simulation result of the analog module and the digital module.

2. The chip verification structure according to claim 1, wherein the analog chip is connected to the FPGA chip at least via a input/output (IO) interface and a communication protocol interface, and the chip verification structure further comprises a control module;
the analog chip is connected to a general-purpose input output (GPIO) interface of the FPGA chip via the IO interface, a first signal output by the analog chip is transmitted to the FPGA chip via the IO interface and the GPIO interface, and a second signal output by the FPGA chip is transmitted to the analog chip via the IO interface and the GPIO interface; and
the analog chip is connected to the FPGA chip via the control module and the communication protocol interface, a third signal output by the analog chip, after being processed by the control module, is transmitted to the FPGA chip via the communication protocol interface, and a fourth signal output by the FPGA chip is transmitted to the control module via the communication protocol interface, processed by the control module and then transmitted to the analog chip.

3. The chip verification structure according to claim 2, wherein the analog chip comprises a plurality of analog modules, and the plurality of analog modules are respectively configured to simulate functions of a plurality of analog function modules of the chip design.

4. The chip verification structure according to claim 3, wherein the chip verification structure further comprises a register file, the register file comprises a plurality of registers, the plurality of registers have a one-to-one mapping relationship with the plurality of analog modules, and the control module transmits the fourth signal which is processed to a corresponding analog module via the register file.

5. The chip verification structure according to claim 2, wherein the communication protocol interface comprises a serial communications interface, and the control module comprises a serial-parallel conversion unit, an encoding and decoding unit, and a processing unit; and
the serial-parallel conversion unit is configured to perform serial-to-parallel conversion processing or parallel-to-serial conversion processing on the third signal or the fourth signal, the encoding and decoding unit is configured to perform encoding processing or decoding processing on the third signal or the fourth signal; and the processing unit is configured to transmit the third signal which is processed to the analog chip and transmit the fourth signal which is processed to the serial communications interface.

6. The chip verification structure according to claim 5, wherein the control module further comprises an error check unit, and the error check unit is configured to perform error check and correction on the third signal or the fourth signal.

7. The chip verification structure according to claim 2, wherein the first signal comprises a timing related signal, the third signal comprises a timing non-related signal, the timing related signal is transmitted via the IO interface, and the timing non-related signal is transmitted via the communication protocol interface.

8. The chip verification structure according to claim 7, wherein the timing related signal comprises a signal that is strongly related to timing control, and the timing non-related signal comprises a signal that is weakly related to timing control.

9. The chip verification structure according to claim 7, wherein the timing related signal comprises an enable signal, a reset signal, a clock signal, a handshake signal, a bus signal, a control signal, and a state signal; and the timing non-related signal comprises a trim signal and a calibration signal.

10. The chip verification structure according to claim 2, wherein the analog chip outputs a waveform via the IO interface, so as to observe a simulation result of the analog chip based on the waveform.

11. The chip verification structure according to claim 1, wherein the analog chip being homologous with the sample of the chip design comprises that the analog chip and the sample of the chip design are from a same multi-project wafer (MPW) wafer.

12. A chip verification system, comprising a chip verification structure,
wherein the chip verification structure comprises an analog chip, the analog chip comprises at least one analog module, and the analog module is configured to simulate a function of an analog function module of a chip design, the analog chip is homologous with a sample of the chip design; and the analog chip is connected to an FPGA chip via a plurality of types of interfaces, the FPGA chip comprises at least one digital module, the digital module is configured to simulate a function of a digital function module of the chip design, and a function of the chip design is verified based on a simulation result of the analog module and the digital module.

13. The chip verification system according to claim 12, wherein the analog chip is connected to the FPGA chip at least via an IO interface and a communication protocol interface, and the chip verification structure further comprises a control module;
the analog chip is connected to a GPIO interface of the FPGA chip via the IO interface, a first signal output by the analog chip is transmitted to the FPGA chip via the IO interface and the GPIO interface, and a second signal output by the FPGA chip is transmitted to the analog chip via the IO interface and the GPIO interface; and
the analog chip is connected to the FPGA chip via the control module and the communication protocol interface, a third signal output by the analog chip, after being processed by the control module, is transmitted to the FPGA chip via the communication protocol interface, and a fourth signal output by the FPGA chip is transmitted to the control module via the communication protocol interface, processed by the control module and then transmitted to the analog chip.

14. The chip verification system according to claim 13, wherein the analog chip comprises a plurality of analog modules, and the plurality of analog modules are respectively configured to simulate functions of a plurality of analog function modules of the chip design.

15. The chip verification system according to claim 14, wherein the chip verification structure further comprises a register file, the register file comprises a plurality of registers, the plurality of registers have a one-to-one mapping relationship with the plurality of analog modules, and the control module transmits the fourth signal which is processed to a corresponding analog module via the register file.

16. The chip verification system according to claim 13, wherein the communication protocol interface comprises a serial communications interface, and the control module comprises a serial-parallel conversion unit, an encoding and decoding unit, and a processing unit; and
the serial-parallel conversion unit is configured to perform serial-to-parallel conversion processing or parallel-to-serial conversion processing on the third signal or the fourth signal, the encoding and decoding unit is configured to perform encoding processing or decoding processing on the third signal or the fourth signal; and the processing unit is configured to transmit the third signal which is processed to the analog chip and transmit the fourth signal which is processed to the serial communications interface.

17. The chip verification system according to claim 16, wherein the control module further comprises an error check unit, and the error check unit is configured to perform error check and correction on the third signal or the fourth signal.

18. The chip verification system according to claim 13, wherein the first signal comprises a timing related signal, the third signal comprises a timing non-related signal, the timing related signal is transmitted via the IO interface, and the timing non-related signal is transmitted via the communication protocol interface.

19. The chip verification system according to claim 18, wherein the timing related signal comprises an enable signal, a reset signal, a clock signal, a handshake signal, a bus signal, a control signal, and a state signal; and the timing non-related signal comprises a trim signal and a calibration signal.

20. A chip verification method, comprising:
performing parameter configuration for an FPGA chip and a chip verification structure, wherein the chip verification structure comprises an analog chip, the analog chip comprises at least one analog module, and the analog module is configured to simulate a function of an analog function module of a chip design; the FPGA chip comprises at least one digital module, and the digital module is configured to simulate a function of a digital function module of the chip design; and the analog chip is connected to an FPGA chip via a plurality of types of interfaces, and the analog chip is homologous with a sample of the chip design;
performing a simulation test on the analog chip via the FPGA chip; and
determining, based on a test result of the analog chip, whether the analog chip satisfies a verification requirement.
